(19) United States
(12) Patent Application Publication
(10) Pub. No.: US 2024/0326833 A1
(43) Pub. Date: Oct. 3, 2024

(54) SYSTEM AND METHOD FOR DETERMINING A VEHICLE'S MAXIMUM VELOCITY

(71) Applicant: MIGAL GALILEE RESEARCH INSTITUTE LTD., Kiryat Shmona (IL)

(72) Inventor: Shaul NASCHITZ, Kibbutz El-Rom (IL)

(73) Assignee: MIGAL GALILEE RESEARCH INSTITUTE LTD., Kiryat Shmona (IL)

(21) Appl. No.: 18/742,258

(22) Filed: Jun. 13, 2024

Related U.S. Application Data
(63) Continuation-in-part of application No. PCT/IL2022/051322, filed on Dec. 14, 2022.
(60) Provisional application No. 63/569,272, filed on Mar. 25, 2024.

(30) Foreign Application Priority Data
Dec. 14, 2021 (IL) 289008

(51) Int. Cl. B60W 40/105; B60W 30/02; B60W 40/072; B60W 50/14

(52) U.S. Cl. CPC B60W 40/105; B60W 30/025; B60W 40/072; B60W 50/14; B60W 2520/10; B60W 2552/20; B60W 2552/35; B60W 2720/10

(57) ABSTRACT

A system and method of determining a vehicle's maximum velocity are disclosed. The system includes a computing device configured to: receive three-dimensional (3D) acceleration data; receive a type of vehicle; receive in real-time a location or velocity of the vehicle on the road during travel when the velocity of the vehicle is higher than a predetermined minimum value; calculate road surface frequency using the 3D acceleration data and the real-time location and/or velocity of the vehicle receive an acceleration threshold for the travel; calculate a maximum recommended velocity for the travel based on the acceleration threshold, the type of the car, the road surface frequency, and the location; and send the calculated maximum recommended velocity to an external computing device wherein the road surface frequency is a mathematical expression of at least one of, the bumpiness and curvature properties of the road.

### CROSS-REFERENCE TO RELATED APPLICATION

This application is a continuation-in-part (CIP) of International Patent Application No. PCT/IL2022/051322 filed on Dec. 14, 2022, which claims the benefit of priority from Israeli Patent Application No. 289008 filed on Dec. 14, 2021.

This application also claims the benefit of priority of U.S. Provisional Application No. 63/569,272, filed on Mar. 25, 2024, the contents of which are hereby fully incorporated by reference in their entirety.

### FIELD OF THE INVENTION

The present invention relates generally to a system and a method for determining a vehicle's maximum velocity. More specifically, the present invention relates to a system and a method for determining a vehicle's maximum velocity as a function of the road surface, the cargo, and/or a user-related parameters.

### BACKGROUND OF THE INVENTION

Traveling and driving on bumpy roads may damage sensitive cargo, such as fragile cargo, soft fruits, etc., may cause discomfort to sensitive passengers, such as a patient evacuated by an ambulance and the like. The higher the traveling velocity the higher is the impact on the cargo/passengers. Currently, the decision, regarding the suitable traveling velocity is made by the driver based on his/her own instincts, but without any knowledge, if the selected traveling velocity is safe enough for the cargo and/or passengers.

Accordingly, there is a need for an automatic system that may provide a maximum velocity indication in real-time to prevent damage to cargo/passengers in the vehicle.

### SUMMARY OF THE INVENTION

Some aspects of the invention are related to a method of determining a vehicle's maximum velocity, comprising: receiving road surface related data indicative of the road surface condition (e.g., three dimensional (3D) acceleration data); receiving a type of a vehicle; receiving in real-time a location and/or velocity of the vehicle on the road during travel when the velocity of the vehicle is higher than a predetermined minimum value; calculating road surface frequency using the 3D acceleration data and the real-time location and/or velocity of the vehicle; receiving an acceleration threshold for the travel; calculating a maximum recommended velocity for the travel based on the acceleration threshold, the type of the car, the road surface frequency, and the location; and sending the calculated maximum recommended velocity to an external computing device, wherein the road surface frequency is a mathematical expression of at least one of, the bumpiness and curvature properties of the road.

In some embodiments, the road surface-related data is received from a database. In some embodiments, the road surface-related data is calculated from measurements received from one or more sensors attached to the vehicle. In some embodiments, the one or more sensors are selected from, a positioning sensor, a camera, an accelerometer, and a speedometer. In some embodiments, the road surface-related data is from data received from other vehicles traveling on the road.

In some embodiments, the predetermined minimum value is at least 0.75 m/s. In some embodiments, receiving at least one of the three-dimensional (3D) acceleration data and the location and/or velocity of the vehicle, is done at a temporal frequency acquisition of at least 0.75 Hz.

In some embodiments, the method further comprises receiving the type of a vehicle from at least one of, a user via a user interface and from the vehicle's computer. In some embodiments, the acceleration threshold of the travel is determined based on at least one of, the type of the vehicle, a type of cargo, and a condition of at least one user traveling in the vehicle.

In some embodiments, the external computing device is at least one of, a user device of a user traveling in the vehicle, a user device of a user associated with the travel, a computing device associated with the user, and a computing device associated with the vehicle.

Some additional aspects of the invention are related to a system for determining a vehicle's maximum velocity, comprising: a computing device configured to: receive road surface-related data indicative of the road surface condition (e.g., a three-dimensional (3D) acceleration data); receive a type of a vehicle; receive in real-time a location or velocity of the vehicle on the road during travel; calculate road surface frequency using the 3D acceleration data and the real-time location and/or velocity of the vehicle receive an acceleration threshold for the travel; calculate a maximum recommended velocity for the travel based on the acceleration threshold, the type of the car, the road surface frequency, and the location; and send the calculated maximum recommended velocity to an external computing device wherein the road surface frequency is a mathematical expression of at least one of, the bumpiness and curvature properties of the road.

In some embodiments, the road surface-related data is received from a database. In some embodiments, the system further comprises one or more sensors attached to the vehicle and wherein the road surface-related data is calculated based on measurements from the one or more sensors. In some embodiments, the one or more sensors are selected from, a positioning sensor, camera, accelerometer, and speedometer. In some embodiments, the road surface-related data is from data received from other vehicles traveling on the road.

In some embodiments, the computing device is further configured to receive the type of a vehicle from at least one of, a user via a user interface and from the vehicle's computer. In some embodiments, the acceleration threshold of the travel is determined based on at least one of, the type of the vehicle, a type of cargo, and a condition of at least one user traveling in the vehicle. In some embodiments, the external computing device is at least one of, a user device of a user traveling in the vehicle, a user device of a user associated with the travel, a computing device associated with the user, and a computing device associated with the vehicle.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a block diagram, depicting a system for determining a vehicle's maximum velocity according to some embodiments;

FIG. 1B is a block diagram, depicting a computing device that may be included in a system for determining a vehicle's maximum velocity according to some embodiments;

FIG. 2A is a block diagram, depicting dataflow in a system for determining a vehicle's maximum velocity according to some embodiments;

FIG. 2B is a flow diagram depicting the road mapping process according to some embodiments of the invention;

FIG. 3 is a flowchart of a method of determining a vehicle's maximum velocity according to some embodiments;

FIG. 4 is a graph depicting the effect of acceleration vector on displacement according to some embodiments of the invention; and

FIG. 5 is a table summarizing data collected by the system during towing experiment according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention disclose a method and a system for determining a vehicle's maximum velocity, for example, when the vehicle is carrying a sensitive cargo or sensitive passengers. Obstacles, such as bumps, holes, cracks, and curves along roads may cause discomfort to passengers, and potential damage to fragile/sensitive cargo, and to automotive systems. The negative impact of the road surface topography and curves on the cargo/passenger is exacerbated by the velocity of the vehicle. Accordingly, a method and system according to embodiments of the invention are configured to ensure safe travel by determining the travel velocity according to the actual road conditions and the cargo/passenger traveling in the vehicle.

In some embodiments, the method may include: receiving road surface-related data indicative of the road surface condition; receiving a type of vehicle; receiving in real-time a location or velocity of the vehicle on the road during travel; receiving an acceleration threshold for the travel; calculating a maximum recommended velocity for the travel based on the acceleration threshold, the type of the vehicle, the road surface frequency, the location, and the travel bearing; and sending the calculated maximum recommended velocity to an external computing device.

As used herein, ‘vehicle’ may be any type of vehicle configured to travel on a road and carry any type of cargo or passengers, including, for example, any truck (e.g., wagon or carriage) towed by the vehicle. For example, a vehicle may be, a car, a truck, a tractor, a tow truck, an ambulance, and the like.

As used herein, ‘road surface-related data’ may include any type of data related to the surface of the road, for example, obstacles (e.g., holes, bumps, cracks, etc.), roughness, unevenness, road curvature, slopes, and the like. The road surface-related data may include, the size of the obstacle, the distance between obstacles, the number of obstacles, the distribution of obstacles, the radius of curvature of each curve, a percentage of a slope, a degree of roughness, a degree of unevenness, measurements of acceleration received from a vehicle traveling on the road, and the like.

In some embodiments, the method may include receiving an acceleration threshold. In some embodiments, more sensitive cargo/passengers are associated with a lower acceleration threshold, as they can withstand only a limited amount of vertical and/or lateral acceleration (e.g., jumps, slide). In some embodiments, the acceleration threshold is determined based on at least one of: the type of the vehicle, a type of cargo, and a condition of at least one passenger traveling in the vehicle. In some embodiments, the acceleration threshold may be experimentally determined according to the type of goods and the packing of the goods. For example, fruit held freely in a container may receive a lower sensitivity level than fruit packed in boxes. In some embodiments, the acceleration threshold may be determined based on the type of passenger. For example, a ride with an infant seated in a safety chair may have a lower acceleration threshold than a ride with adult passengers only. In yet another example, a ride of an ambulance evacuating a patient may receive a lower acceleration threshold than a ride of any other vehicle with healthy passengers.

In some embodiments, the maximum velocity for the vehicle may be determined based on the type of vehicle, the road surface-related data, and the acceleration threshold. In some embodiments, the maximum velocity may be sent to a user device (e.g., the mobile phone of the driver), or an external device (e.g., the car computer) to be either presented to the driver or control the engine of the vehicle (e.g., in autonomous vehicles).

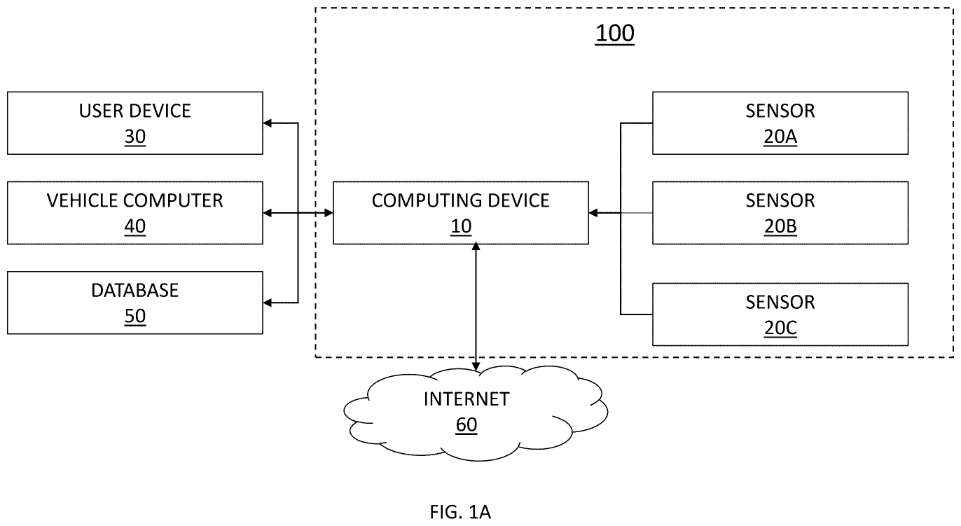

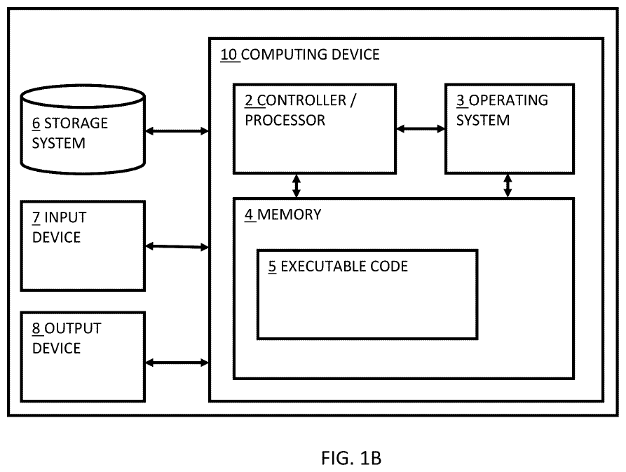

Reference is now made to FIG. 1A which is a block diagram, depicting a system for determining a vehicle's maximum velocity according to some embodiments. According to some embodiments of the invention, system 100 may be implemented as a software module, a hardware module, or any combination thereof. For example, system 100 may be or may include a computing device such as computing device 10 of FIG. 1B and may be adapted to execute one or more modules of executable code (e.g., element 5 of FIG. 1B) to determine a vehicle's maximum velocity, as further described herein.

A system 100 may be included in the vehicle, communicate with the vehicle's computer, or may be attached to the vehicle. System 100 may include a computing device 10, discussed in detail with respect to FIG. 1B, and one or more sensors 20A, 20B, and 20C. Sensor 20A may be a positioning sensor, such as a GPS receiver, associated with the car and configured to provide information related to the real-time location of the vehicle on the road. Sensor 20B may be a gyroscope and/or an accelerometer configured to provide acceleration measurements in at least two axes. Sensor 20C may be a speedometer measuring the velocity of the vehicle. In some embodiments, other sensors may be included in system 100 or may be in communication with computing device 10, for example, distance measuring devices, time measuring devices, cameras calibrated for various light spectra etc.

In some embodiments, computing device 10 may be in communication with additional devices, such as a user device 20 (e.g., a mobile device, smartphone, tablet, PC, and the like), the vehicle computer 40, and an external database 50. Computing device 10 may communicate with each device wirelessly or by wired communication. In some embodiments, computing device 10 may be in communication with additional computing devices over a network such as an internet 60. For example, computing device 10 may receive information from computing devices 10 of other vehicles traveling on the same road, traveling on other roads, and the like.

Reference is now made to FIG. 1B, which is a block diagram depicting a computing device, which may be included within an embodiment of a system for determining a vehicle's maximum velocity, according to some embodiments.

Computing device 10 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 10 may be included in, and one or more computing devices 10 may act as the components of, a system 100 according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 10, for example, scheduling execution of software programs or tasks or enabling software programs or other modules or units to communicate. Operating system 3 may be a commercial operating system. It will be noted that operating system 3 may be an optional component, e.g., in some embodiments, a system may include a computing device that does not require or include an operating system 3.

Memory 4 may be or may include, for example, a Random Access Memory (RAM), a read-only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task or script. Executable code 5 may be executed by processor or controller 2 possibly under the control of operating system 3. For example, executable code 5 may be an application that may determine a vehicle's maximum velocity as further described herein. Although, for the sake of clarity, a single item of executable code 5 is shown in FIG. 1B, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a microcontroller or chip as known in the art, a hard disk drive, a CD-Recordable (CD-R) drive, a Blu-ray disk (BD), a universal serial bus (USB) device or other suitable removable and/or fixed storage unit. Road surface-related data, the vehicle's data and parameters, parameters of the cargo, and the like may be stored in storage system 6 and may be loaded from storage system 6 into memory 4 where it may be processed by processor or controller 2. In some embodiments, some of the components shown in FIG. 1B may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components or systems, e.g., a detachable keyboard or keypad, a mouse, and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

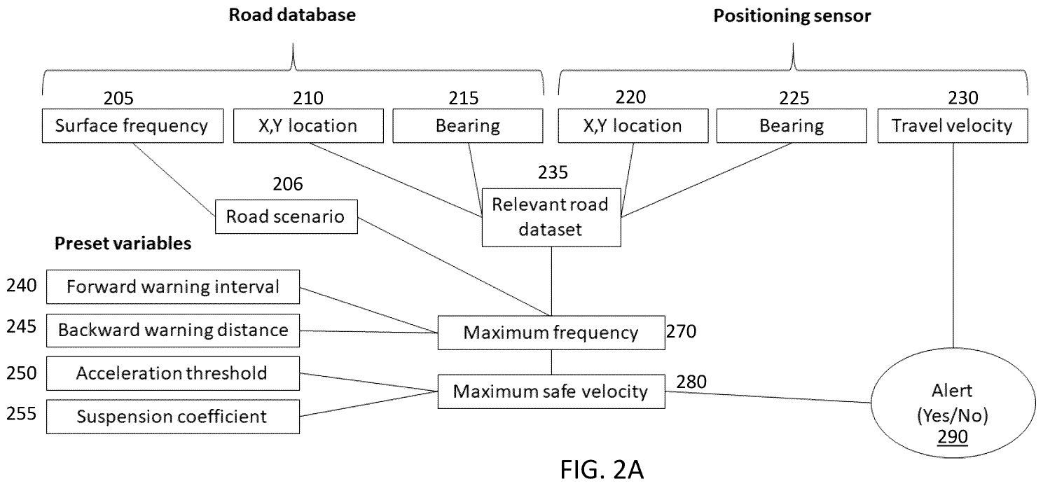

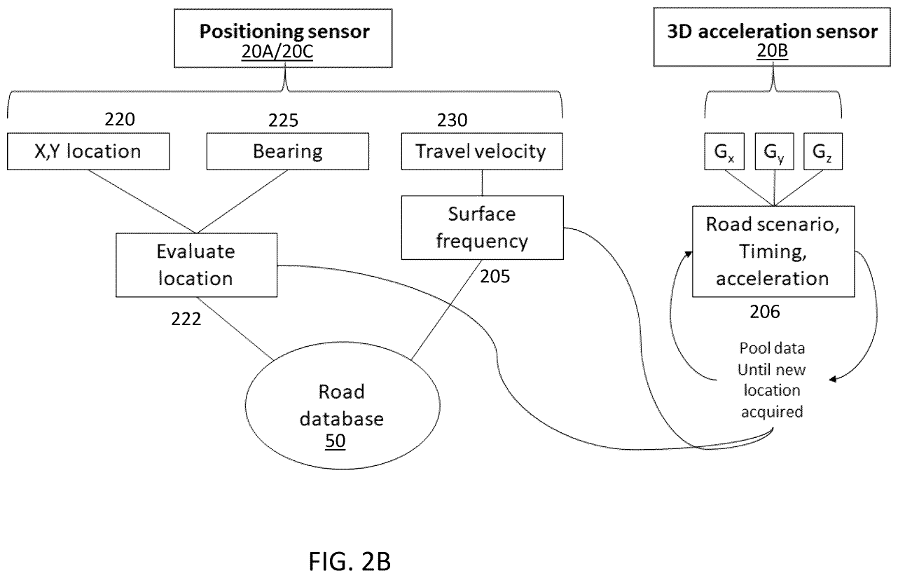

Reference is now made to FIG. 2B which is a block diagram depicting data flow in a system for determining a vehicle's maximum velocity according to some embodiments. The first input may include road surface-related data indicative of the road surface condition received from a road database. The road surface-related data may include surface frequency 205, road locations data 210 (e.g., location/velocity of the vehicle), and bearing 215. Surface frequency 205 is a mathematical expression of the bumpiness and/or curvature properties of the road. Surface frequency 205 may be calculated from 3D acceleration data measured by sensors 20B (e.g., a gyroscope and/or accelerometer) using equation (1) or the equations in table 1 or may be calculated from data related to obstacles along the road, such as the size of the obstacle, the distance between obstacles, the number of obstacles, distribution of obstacles, a degree of roughness, a degree of unevenness, and the like.

$$f = \frac{a ( {a}_{x} , {a}_{y} , {a}_{z} )}{v} \qquad ( 1 )$$

wherein, f is the surface frequency, a is the 3D acceleration vector and v the travel velocity received from sensors 20A or 20C.

The three spatial axes of the acceleration, aₓ, a_{y}, and a_{z}, possess differing effects on travel safety).

In some embodiments, the surface frequency may be calculated using one or more components of the 3D acceleration vector, which is referred herein as “acceleration data”. The selection of aₓ, a_{y}, and/or a_{z} is done based on a traveling scenario. A nonlimiting example for using “acceleration data “at different scenarios is given in table 1. Acceleration aₓ along the x-axis (left/right) is prevalent in traveling along curves, is responsible for overturning of the vehicle. While this usually may occur at unrealistically high velocity, skidding of untethered passengers and/or objects inside the vehicle may cause significant damage. x-axis acceleration is not affected by the suspension characteristics of the vehicle. Acceleration a_{y} along the y-axis (up/down) is prevalent in travel along a bumpy road, is responsible for passengers and objects momentarily losing ground. The vehicle's suspension characteristics have a large impact on y-axis acceleration. Acceleration a_{z} along the z-axis (front/back) is caused largely by changes of velocity while traveling a straight road, has little meaningful effect on travel safety and must be largely ignored, except in curves.

In some embodiments, the road surface frequency calculations are performed only when the vehicle's velocity is greater than a predetermined minimum value (for example, 1.0 m/s, 0.55 m/s, 0.6 m/s, 0.75 m/s, 0.8 m/s, 1.1 m/s, 1.2 m/s or more), as calculated surface frequency at very low velocities may be highly sensitive to inaccuracies in acceleration measurement. A high temporal frequency of positioning and/or acceleration acquisition (typically 1 Hz, for example, at least 0.5 Hz, at least 0.8 Hz, at least 1 Hz, at least 1.5 Hz or more) may be required to isolate the effect of road conditions on calculated surface frequency, while minimizing the effect of the driver behavior.

The equations in table 1 are used to determine relevant road frequency by considering two scenarios 206: a curve in the road and a bump in the road. Road scenario 206 is reflected in a Boolean variable signaling which of the scenarios is prevalent in a road section. Maximum safe velocity is thus calculated according to the value carried on from a mapping stage illustrated and discussed with respect to FIG. 2B.

TABLE 1

| | | Road frequency | Bump |
|---|---|---|---|
| Condition | Interpretation | calculation | criterion |
| \sqrt{αₓ²} > \sqrt{α_{y}²} | A curve in the road | ${f}_{i} = \frac{\sqrt{{a}_{x}^{2} + {a}_{y}^{2} + {a}_{z}^{2}}}{{V}_{a}}$ | 0 |
| \sqrt{α_{y}²} ≥ \sqrt{αₓ²} | A bump in the road | $fi = \frac{{S}_{m} \times \sqrt{{a}_{y}^{2}}}{{V}_{a}}$ | 1 |

### Where,

fᵢ=momentary road frequency (Hz).
Vₐ=momentary traveling velocity (m/s).
Sₘ=mapping suspension coefficient (pre-set)

In some embodiments, the type of sensors 20A or 20C, and particularly the sensing frequency may be taken into account when calculating the surface frequency. In some embodiments, acceleration measurement frequency may vastly exceed positioning acquisition frequency (e.g., 60 Hz and 1 Hz, respectively). In order to take advantage of the relative abundance of acceleration data, it may be desired to evaluate the locations at which individual acceleration measurements were taken even in the absence of corresponding positions. This may be achieved by pooling the acceleration values and measurement times between successive acquisitions of positioning data, as described in equations 2 and 3a-3d.

Equation 2 is an approximation of the relative distance of individual acceleration measurement instances.

$${rL}_{a} = \frac{{V}_{i - 1} \times ( {T}_{a} - {T}_{i - 1} )}{{V}_{i} \times ( {T}_{i} - {T}_{i - 1} )} \qquad ( 2 )$$

Where: rLₐ=relative distance of an individual acceleration measurement; Tₐ=time of individual acceleration measurement; Tᵢ=acquisition time of current location; Tᵢ₋₁=acquisition time of previous location; Vᵢ=current velocity; and Vᵢ₋₁=previous velocity, received from the sensors.

Equations 3a, 3b, 3c and 3d are approximations of the position, velocity and bearing of individual acceleration measurements.

$${V}_{a} = \frac{{V}_{i} \times {rL}_{a} + {V}_{i - 1} \times ( 1 - {rL}_{a} )}{2} \qquad ( 3 a )$$

$${Lat}_{a} = \frac{{Lat}_{i} \times {rL}_{a} + {Lat}_{i - 1} \times ( 1 - {rL}_{a} )}{2} \qquad ( 3 b )$$

$${Lon}_{a} = \frac{{Lon}_{i} \times {rL}_{a} + {Lon}_{i - 1} \times ( 1 - {rL}_{a} )}{2} \qquad ( 3 c )$$

$${Bearing}_{a} = \frac{{Bearing}_{i} \times {rL}_{a} + {Bearing}_{i - 1} \times ( 1 - {rL}_{a} )}{2} \qquad ( 3 d )$$

### Where:

Vₐ, Latₐ, Lonₐ, Bearingₐ are the approximations of travel parameters at the time of individual acceleration measurements.
rLₐ =relative distance of individual acceleration measurements.
Vᵢ, Latᵢ, Lonᵢ, Bearingᵢ are the current measured values of travel variables.
Vᵢ₋₁, Latᵢ₋₁, Lonᵢ₋₁, Bearingᵢ₋₁ are the previous measured values of travel variables.

In some embodiments, surface frequency 205 may be received from other vehicles traveling on the road (e.g., measured and/or calculated by computing devices associated with these vehicles), for example, via internet 60. In some embodiments, a network of vehicles may provide road surface-related data, such as surface frequency 205 to other vehicles connected to the network.

In some embodiments, road bearing 215 may include data related to the path of the road, for example, a radius of curvature of each curve in the road, a percentage of each slope of the road, and the like.

In some embodiments, after calculating the road surface-related data additional data may be received from one or more sensors 20A-20C and/or database 50. For example, current location 220 and travel velocity 230 (e.g., v) may be received from positioning sensor 20A and/or speedometer 20C and the current bearing 225 may be received from sensor 20B or database 50.

In some embodiments, when combined together surface frequency 205, location 210, road bearing 215, current location 220, current bearing 225 and travel velocity 230 may all be included in a relevant road dataset 235.

In a non-limiting example, a maximum surface frequency 270 of a road section may be calculated using at least some of data: relevant road dataset 235, a forward warning interval 240, and a backward warning interval 245. In some embodiments, forward warning interval 240 is defined as a time interval required for the driver to adjust the velocity. Forward warning distance 240 may be calculated from relevant dataset 235 by multiplying forward warning interval 240 by the travel velocity 230.

In some embodiments, backward warning interval 245 is used only when cargo is towed by the vehicle and is defined as the length of the cargo towed by the vehicle. In some embodiments, the road frequency values recorded (e.g., in storage system 6) for a relevant road section, stretching between the vehicle's location and backward and forward warning distances, may be received (e.g., form storage system 6) and multiplied by the travel velocity 230. rec.

In the non-limiting example above, a maximum safe velocity 280 may be calculated from the maximum surface frequency 270, an acceleration threshold 250 and a suspension coefficient 255. In some embodiments, acceleration threshold 250 is defined as the maximum acceleration allowed. Acceleration threshold 250 depends on the allowed displacement and is experimentally or empirically determined and stored in a database, such as, storage system 6. The database may include a lookup table associating different types of cargos and/or passengers with acceleration threshold of the carried passenger/cargo. Table 2 in a nonlimiting example for a lookup table associating different types of cargos and/or passengers with acceleration thresholds.

TABLE 2

| | Recommended |
|---|---|
| | acceleration threshold |
| Scenario | (m/s²) |
| Ambulance carrying a spinal injury patient | 8 |
| Truck carrying loose gravel | 8.5 |
| School bus carrying young children | 8.5 |
| Tractor pulling apple crates | 9 |
| Delivery truck carrying fragile cargo | 9 |
| Vehicle mechanical systems | 9.8 |

In some embodiments, suspension coefficient 255 is defined as a value depicting the resistance of the vehicle's suspension systems. Suspension coefficient 255 may be received from vehicle's computer 40 or a database associated with the vehicle, for example, a database of the vehicle's manufacturer. Accordingly, the maximum safe velocity 280 can be calculated from equation 4

$${V}_{m a x} = \frac{{a}_{m a x}}{{f}_{m a x}} \times {R}_{suspension} \qquad ( 4 )$$

Wherein, aₘₐₓ is acceleration threshold 250, fₘₐₓ is maximum surface frequency of a road section 270 and Rₛᵤₛₚₑₙₛᵢₒₙ, is suspension coefficient 255.

In another non-limiting example, maximum safe velocity 280 may be calculated using equation 5 and the following data:
a. The result of division of a_{crit} (acceleration threshold) to the maximum road frequency in the relevant section.
b. Suspension coefficient of the vehicle, only used for road bumps.
c. Sensitivity to angular acceleration, only used for road curves.

$${V}_{m a x} = \frac{{a}_{crit}}{{f}_{m a x}} \times {S}^{C} \times {( \frac{{a}_{crit}}{9.8} )}^{( 2 - 2 C )} \qquad ( 5 )$$

### Where,

a_{crit}=acceleration threshold as determined by passenger/cargo sensitivity (m/s²). Pre-set.
fₘₐₓ=maximum road frequency, as calculated in Table 1, in the alert range (Hz).
S=a vehicle-specific suspension coefficient (pre-set).
C=bump criterion; a Boolean value determined by the road scenario, as in Table 1.

In some embodiments, if the maximum safe velocity 280 is lower than travel velocity 230 a signal comprising an alert may be sent to an external device, such as, the user device 30, vehicle's computer 40, a remote computing device over internet 60, a speaker and the like. In some embodiments, if the vehicle is an autonomous vehicle, vehicle's computer 40 may reduce travel velocity 230 to be equal to or lower than maximum safe velocity 280.

Reference is now made to FIG. 2B which is a flow diagram depicting the road mapping process according to some embodiments of the invention. The result of the mapping process in road surface related data 200. Current location 220, current bearing 225 and travel velocity 230 may be received from positioning sensor 20A and/or velocity sensor 20C. The 3D acceleration data may be received from a 3D acceleration sensor 20B. Surface frequency 205 may be calculated based on the 3D acceleration data and travel velocity 203, for example, using equation 1 and/or the equations in table 1, according to a road scenario 206. Road scenario 206 may be determined from the 3D acceleration data. Surface frequency 205 may continuously be calculated until current location 220 may be acquired. When current location 220 is acquired, location 222 may be evaluated from current location 220 and bearing 225 and be associated with a corresponding surface frequency 205. Evaluated location 222 and the corresponding surface frequency 205 may be used for calculating maximum safe velocity 280 and/or be saved in road database 50.

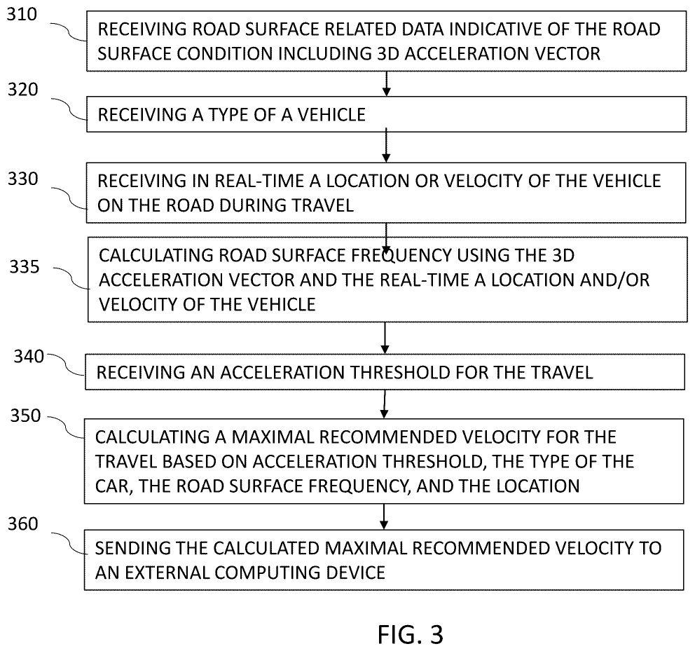

Reference is now made to FIG. 3 which is a flowchart of a method for determining a vehicle's maximum velocity according to some embodiments of the invention. The method of FIG. 3 may be performed by computing device 10 of system 100 or by any other computing device.

In step 310, computing device 10 may receive three-dimensional (3D) acceleration data, for example, from one or more sensors 20B.

In step 320, the type of the vehicle may be received, for example, from database 50, from a user via user device 30, and/or from the vehicle's computer 40. The type of vehicle may define properties of the vehicle, such as one or more dimensions of the vehicle, does the vehicle includes a wagon, the resistance of the vehicle's suspension systems, and the like.

In step 330, a location, bearing and/or velocity of the vehicle on the road during travel may be received in real-time, when the velocity of the vehicle is greater than a predetermined minimum value, for example, from positioning sensor 20A and/or speedometer 20C.

In some embodiments, the predetermined minimum value is at least 0.75 m/s, for example, 1.0 m/s, 0.8 m/s, 0.9 m/s, 1.1 m/s, 1.2 m/s or more. In some embodiments, receiving at least one of the a three-dimensional (3D) acceleration data and the location and/or velocity of the vehicle, is done at a temporal frequency acquisition of at least 0.75 Hz, for example, 0.8 Hz, 1 Hz, 1.1 Hz, 1.2 Hz, 1.5 Hz, 2 Hz, or more.

In step 335, road surface frequency may be calculated using the 3D acceleration data and the real-time location and/or velocity of the vehicle. For example, equation 1 and the equations in table 1 may be used for calculating road surface frequency 205, at different road scenarios 206. In some embodiments, road surface frequency 205 is a mathematical expression of at least one of, the bumpiness and curvature properties of the road.

In some embodiments, surface frequency 205, road locations data 210 (e.g., location/velocity of the vehicle), and bearing 215, may be included in road surface related data, as discussed hereinabove. In some embodiments, the road surface-related data is received from database 50. In some embodiments, road surface-related data is calculated from one or more sensors 20A, 20B, and/or 20C attached to the vehicle. In some embodiments, the one or more sensors are selected from, a positioning sensor, camera, distance sensor, accelerometer, gyroscope, and speedometer.

In some embodiments, the road surface-related data is from data received from other vehicles traveling on the road. For example, sensory data, such as 3D acceleration data, positions, bearing, and the like collected by sensors of other vehicles may be received from the computing devices of these vehicles. Other data such as the size of the obstacle, the distance between obstacles, the number of obstacles, distribution of obstacles, a radius of curvature of each curve, a percentage of a slope, a degree of roughness, a degree of unevenness, and the like, may be received from other sources. Some examples for such sources may include, municipality/governmental/private databases storing data related to roads maintenance.

In step 340, a maximum acceleration threshold, indicating the sensitivity level, may be received, for example, from a database. In some embodiments, the acceleration threshold of the travel is determined based on at least one of, the type of the vehicle, a type of cargo, and a condition of at least one user traveling in the vehicle, as discussed herein above with respect to FIGS. 2A and 2B.

In step 350, a maximum recommended velocity for the travel may be calculated based on the received acceleration threshold, the type of the vehicle, the road surface frequency, and the location, using for example, equations 4 or 5.

In step 360, the calculated maximum recommended velocity may be sent, as a signal, to an external computing device. In some embodiments, the external computing device is at least one of a user device of a user traveling in the vehicle, a user device of a user associated with the travel (e.g., a computing device of a company/entity owning the cargo, a computing device of an ambulance service and the like), the vehicle's computer, a computing device associated with the user, and a computing device associated with the vehicle (e.g., a computing device of the vehicle's insurance company). In some embodiments, the method may include a comparison between the maximum recommended velocity and the travel velocity and sending a signal comprising an alert, when the maximum recommended velocity is below the travel velocity.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

### Experimental Results

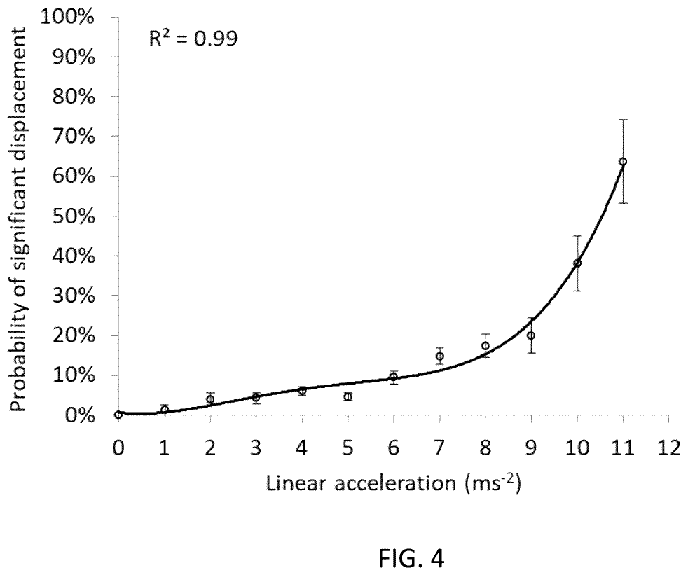

The safe velocity was calculated for a travel of a crate of apples pulled by a tractor on a bumpy road. The 3D acceleration vector was calculated, for signals received from sensors such as sensors 20B, at 30 Hz intervals along with the travel. A camera was positioned above the crate and the positions of individual apples at the top layer of fruits was monitored. “Significant displacement” was defined as a 5 mm or larger shift in the position of at least one apple in the camera's field of view. FIG. 4 shows a graph of the probability for having a displacement larger than 5 mm of at least one apple as a function of the acceleration. The test drive comprised approximately 5,000 individual measurements of acceleration/displacements. Acceleration values were grouped into groups of 1, 2, 3, 4, 5, 6, 7, 8, 9, and 10 m/s2 groups, and the probability of significant displacement was calculated for each group. As clearly shown in the graph, the higher the acceleration the higher is the probability for a displacement.

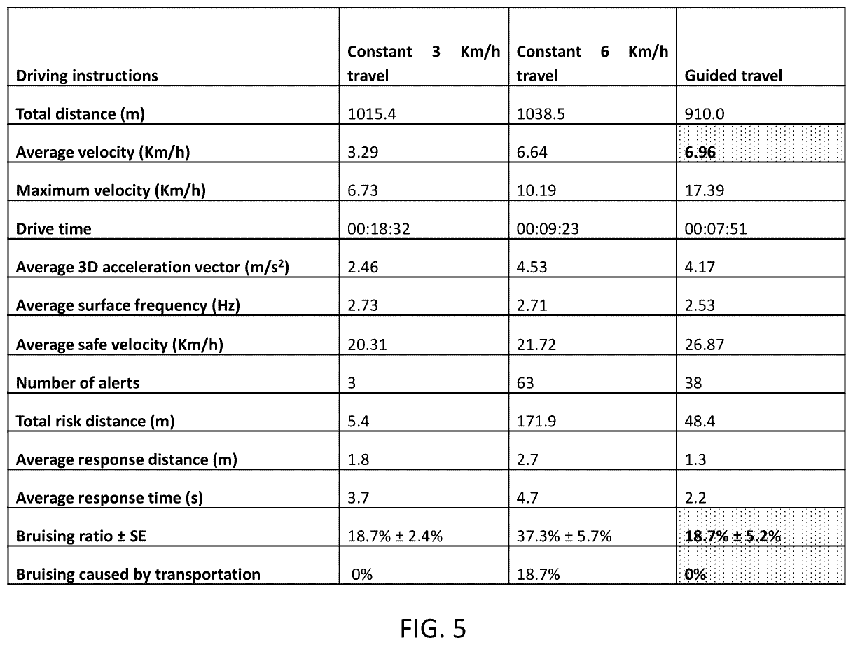

FIG. 5 in a table summarizing data collected by system 100 during a towed experiment. A row made of five crates of apples was pulled by a tractor on a pre-selected bumpy road. The driver was instructed to repeat the journey three times: a) while maintaining a constant speed of 3 Km/h, b) a constant speed of 6 Km/h or c) while responding to the system's alerts. The number of bruised apples in a sample of 50 was visually determined at the end of each journey. As clearly shown in the table, the guided travel allowed to increase the average traveling velocity to almost 7 Km/h while maintaining 0% of bruising caused by transportation, as was achieved in traveling at 3.3 Km/h.

During the towed tests, location coordinates and travel velocity were recorded at 1 second intervals during the travel. Simultaneously, acceleration data was measured at 60 Hz. For each location along the route, the maximum 3D acceleration vector measured during the previous 1 second interval was recorded. An acceleration threshold equaling 9.8 m/s² and a suspension coefficient equaling 1.0 were set. For each location along the route, road frequency was calculated using equation (1). The maximum safe velocity for each location was calculated using the equation (2). Using the data recorded during each of the three journeys, average safe velocity was calculated. For each case in which acceleration surpassed 9.8 m/s², the time and distance that passed from receiving an alert until travel velocity dropped beneath the relevant maximum safe velocity were calculated. Those values were then averaged for each journey. ‘Bruising ratio’ is the average proportion of bruised apples in three different containers. ‘Bruising caused by transportation’ is the difference between initial and final average bruising ratios.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of determining a vehicle's maximum velocity, comprising:
receiving a three-dimensional (3D) acceleration data;
receiving a type of a vehicle;
receiving in real-time a location and/or velocity of the vehicle on the road during travel, when the velocity of the vehicle is higher than a predetermined minimum value;
calculating road surface frequency using the 3D acceleration data and the real-time location and/or velocity of the vehicle;
receiving an acceleration threshold for the travel;
calculating a maximum recommended velocity for the travel based on the acceleration threshold, the type of the car, the road surface frequency, and the location; and
sending the calculated maximum recommended velocity to an external computing device,
wherein the road surface frequency is a mathematical expression of at least one of, the bumpiness and curvature properties of the road.

2. The method of claim 1, wherein the road surface-related data is received from a database.

3. The method of claim 1, wherein the road surface-related data is calculated from measurements received from one or more sensors attached to the vehicle.

4. The method of claim 3, wherein the one or more sensors are selected from, a positioning sensor, camera, an accelerometer, and a speedometer.

5. The method of claim 1, wherein the road surface-related data is from data received from other vehicles traveling on the road.

6. The method of claim 1, wherein the predetermined minimum value is at least 0.75 m/s.

7. The method of claim 1, wherein, receiving at least one of the three-dimensional (3D) acceleration data and the location and/or velocity of the vehicle, is done at a temporal frequency acquisition of at least 0.75 Hz.

8. The method of claim 1, further comprising, receiving the type of a vehicle from at least one of, a user via a user interface and from the vehicle's computer.

9. The method of claim 1, wherein the acceleration threshold of the travel is determined based on at least one of, the type of the vehicle, a type of cargo, and a condition of at least one user traveling in the vehicle.

10. The method of claim 1, wherein the external computing device is at least one of, a user device of a user traveling in the vehicle, a user device of a user associated with the travel, a computing device associated with the user, and a computing device associated with the vehicle.

11. A system for determining a vehicle's maximum velocity, comprising:
a computing device configured to:
receive a three-dimensional (3D) acceleration data; receive a type of a vehicle;
receive in real-time a location and/or velocity of the vehicle on the road during travel when the velocity of the vehicle is higher than a predetermined minimum value.
calculate road surface frequency using the 3D acceleration data and the real-time location and/or velocity of the vehicle;
receive an acceleration threshold for the travel;
calculate a maximum recommended velocity for the travel based on the acceleration threshold, the type of the car, the road surface frequency, and the location; and
send the calculated maximum recommended velocity to an external computing device,
wherein the road surface frequency is a mathematical expression of at least one of, the bumpiness and curvature properties of the road.

12. The system of claim 11, wherein the road surface-related data is received from a database.

13. The system of claim 11, further comprising one or more sensors attached to the vehicle and wherein the road surface-related data is calculated based on measurements from the one or more sensors.

14. The system of claim 13, wherein the one or more sensors are selected from, a positioning sensor, camera, accelerometer, and speedometer.

15. The system of claim 11, wherein the road surface-related data is from data received from other vehicles traveling on the road.

16. The system of claim 11, wherein the predetermined minimum value is at least 0.75 m/s.

17. The system of claim 11, wherein, receiving at least one of the three-dimensional (3D) acceleration data and the location and/or velocity of the vehicle, is done at a temporal frequency acquisition of at least 0.75 Hz.

18. The system of claim 11, wherein the computing device is further configured to receive the type of a vehicle from at least one of, a user via a user interface and from the vehicle's computer.

19. The system of claim 11, wherein the acceleration threshold of the travel is determined based on at least one of, the type of the vehicle, a type of cargo, and a condition of at least one user traveling in the vehicle.

20. The system of claim 11, wherein the external computing device is at least one of, a user device of a user traveling in the vehicle, a user device of a user associated with the travel, a computing device associated with the user, and a computing device associated with the vehicle.
